(19) United States
(12) Patent Application Publication
(10) Pub. No.: US 2002/0070967 A1
(43) Pub. Date: Jun. 13, 2002

(54) Method and apparatus for map display of news stories

(76) Inventors: Timothy T. Tanner, Colorado Springs, CO (US); Richard D. Shapiro, Colorado Springs, CO (US); William H. Brown, Colorado Springs, CO (US)

Correspondence Address: EPSTEIN, EDELL, SHAPAIRO & FINNAN, LLC, Suite 400, 1901 Research Boulevard, Rockville, MD, 20850-3164, US

(21) Appl. No.: 09/733,638

(22) Filed: Dec. 8, 2000

(51) Int. Cl. G06F 3/14

(52) U.S. Cl. 345/764

(57) ABSTRACT

A method of displaying information relating to a news story by a computer system, comprising the steps of, receiving the news story, determining whether the news story has preprogrammed story content, determining whether the news story corresponds to a preprogrammed location which is associated with the preprogrammed story content, and displaying a story indicator on a map at the preprogrammed location if it is determined that both the preprogrammed story content and preprogrammed location are present. It is determined whether the news story has at least one of preprogrammed hotwords and preprogrammed activities.

### BACKGROUND OF THE INVENTION

A. Field of the Invention

The present invention is directed to the field of automically displaying information in a map mode.

B. Description of Related Art

The “wire services” (e.g. Reuters, Associated Press, etc.) provide news stories to subscribers serially, that is, one after the other. They frequently come in over a dedicated terminal, and it is incumbent upon personnel tasked with the job of looking out for certain types of stories to keep constant watch on the terminal. This is a tedious job and may result in the wire service being underutilized. At some point, the information available from wire services may be available on the Internet.

To make the wire service more available to users, it is desirable to present incoming news stories in a map display format. That is, after filtering for preselected story content, icons representative of individual stories are presented on an electronic map at the place of origin of the stories. This has many advantages, one of which is that groups of stories occurring at common locations can be quickly spotted.

One such mapping system for news stories is disclosed in U.S. Pat. No. 5,671,342. However, a disadvantage of the prior art system is that it processes and displays stories corresponding to all geographical locations for which the system is set up. After display of all such locations, the user can hone in on the locations of interest to him by a “rubberbanding” or similar selection technique. This involves extra steps on the part of the user and results in the processing/display of unnecessary information. Also, while the patent mentions “filtering” to select stories of interest, there is no modality disclosed for rapidly and efficiently ascertaining just which stories are “interesting”.

### SUMMARY OF THE INVENTION

In accordance with a first aspect of the present invention, a method of displaying information relating to a news story is disclosed, comprising the steps of,

receiving the news story,

determining whether the news story has preprogrammed story content,

determining whether the news story corresponds to a preprogrammed location which is associated with the story content, and

displaying a story indicator on a map at the preprogrammed location if it is determined that both preprogrammed story content and preprogrammed location are present.

In accordance with a second aspect of the invention, the step of determining whether the news story has preprogrammed story content comprises determining whether the news story has at least one of preprogrammed hotwords and preprogrammed activities.

In accordance with a further aspect of the invention, the step of determining whether the news story has at least one of preprogrammed hotwords and preprogrammed activities comprises first determining whether the news story has preprogrammed hotwords.

Other and additional aspects of the invention will be manifest to the reader of the following disclosure, which is comprised of specific embodiments, while the invention covered is defined in the claims which follow the disclosure.

### BRIEF DESCRIPTION OF DRAWINGS

The invention will be better appreciated by referring to the accompanying drawings, wherein:

FIG. 1 illustrates a computer system on which an embodiment of the invention can be implemented.

FIG. 2 shows a typical electronic map screen capture display.

FIG. 3 depicts a method according to an embodiment of the invention.

FIGS. 4 to 10 illustrate further screen capture displays.

FIG. 11 depicts a method according to an embodiment of the invention.

### DETAILED DESCRIPTION OF PREFERRED EMBODIMENT

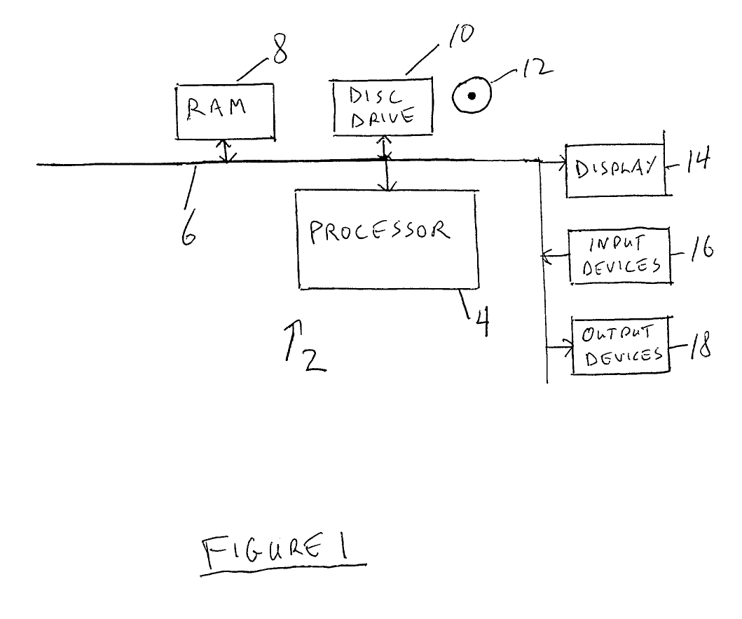

FIG. 1 is a block diagram of a computer system 2 in which the present invention can be implemented. Referring to the Figure, a processor 4 is shown, which is coupled to bus 6, which is used for communication. Also coupled to the bus is random access memory 8 which stores information and instructions to be executed by the processor 4.

A device for inputting instructions provided by a computer readable medium is also coupled to bus 6. For instance, this may be disc drive 10 for a CD-ROM 12, which is one example of a computer readable medium which may be used. Other storage devices as may be necessary or appropriate for particular situations may also be incorporated in computer system 2.

The computer system is coupled to display device 14, which for example may be a cathode ray tube or a flat screen device such as an LCD. Input devices 16, which, for example, may include a keyboard and cursor control is also coupled to the processor for entering commands and controlling cursor movement. The computer may be coupled to well known output devices 18, such as a printer and loudspeaker. The computer may be a stand alone device or may be part of a network. In either case, news stories are fed to an electrical connection that comprises an input to the computer.

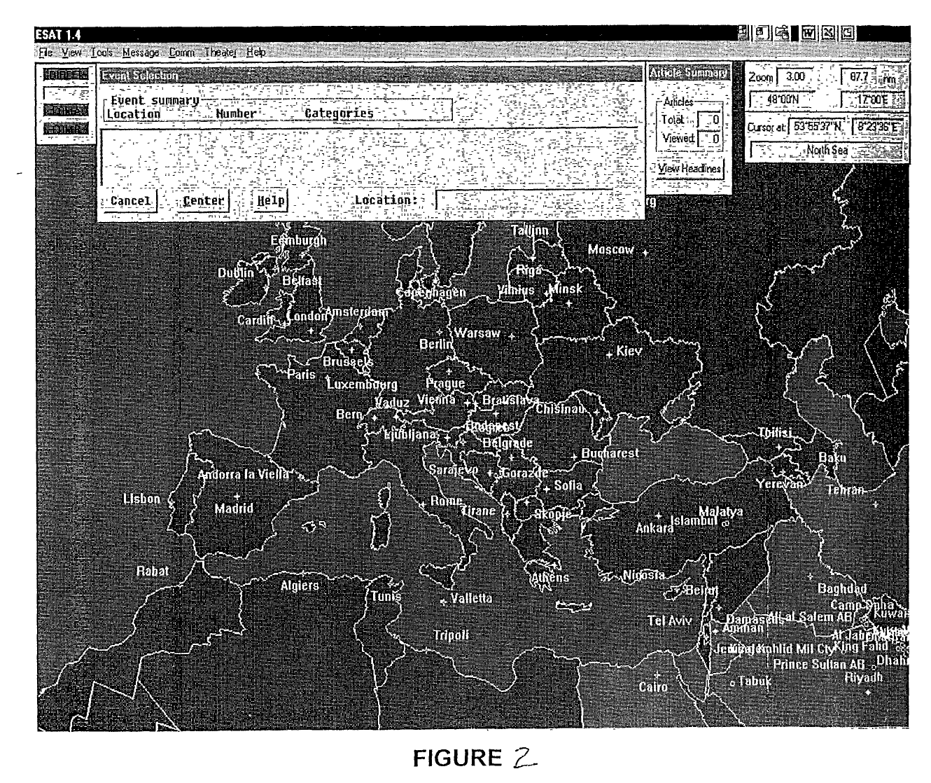

FIG. 2 shows a screen display presenting a regional map which in the example given, is denoted as being of the European region. Each regional (or worldwide) display is known as a “theater”, and different theaters may be selected by the user. In the screen display of FIG. 2, there are no story indicators or icons yet present.

In accordance with the present embodiment, the user selects or programs as preconditions both geographical areas of interest and at least one of the hotwords and activities of interest. During operation, stories are received and it is determined whether preprogrammed geographical locations are present, and if so, if at least one of the hotwords and activities of interest associated with the location is present. If so, a correlation or match is indicated and an appropriate icon is presented on the map at the geographical area of interest. Those stories which are correlated and those which are not are separated for appropriate accessing by the user.

A “hotword” as used herein, is textual material which in and of itself signifies information which is of a high level of interest to the user, and for example, may be a person, place, thing, or event.

An “activity” as used herein is signified by the occurrence in the story of a threshold number of user selected words and phrases, which together are sufficient to indicate the presence of the activity. For example, a user may be interested in the activity of “natural disasters”, which would be recognized by the occurrence of some of the following words and phrases in an article: earthquakes, hurricanes, flood, flooding, blizzards, strong winds, severe lightning, killer diseases, diseases, and humanitarian aid. On a case by case basis, the user indicates how many of these words must appear in an article before the article is considered to be “interesting” in regard to this “activity”. As used herein the plurals of the terms “hotword” and “activity” are to be construed as including both the singular and plural.

As another example, which illustrates the use of hotwords, the user may want to know about terrorism in Saudi Arabia, but more specifically about terrorism associated with the international terrorist Osama Bin Laden. The user would then program Osama Bin Laden as a hotword along with the activity “terrorism”, both of which would be associated with the location Saudi Arabia. The activity “terrorism” would be programmed by selecting a requisite number of words and phrases associated with this activity. However, once it is determined that the hotword “Osama Bin Laden” is present in the story, the user's object may be accomplished, and it is not necessary to also determine whether the activity “terrorism” is present by searching for multiple words and phrases.

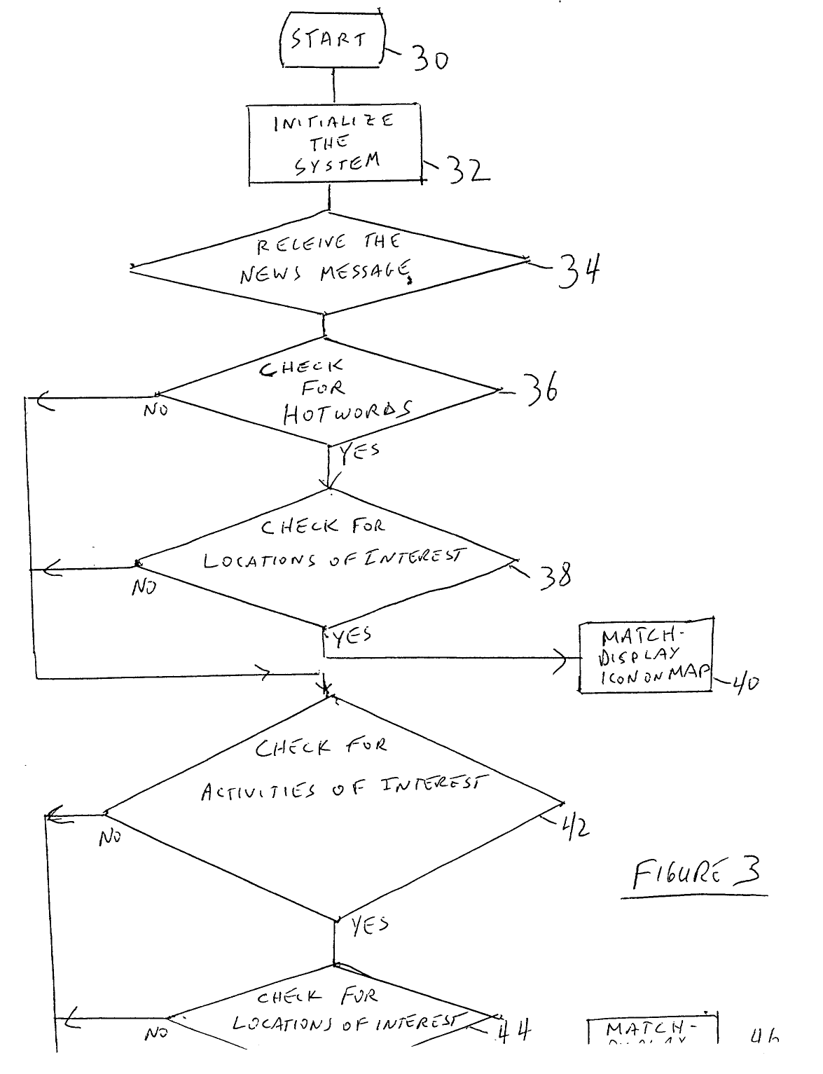

FIG. 3 is a flow chart depicting a method according to an embodiment of the invention. It may be implemented on a computer system as shown in FIG. 1, and the programming instructions for accomplishing the method may be present on the computer readable medium 12.

Referring to FIG. 3, step 30 represents the start of the method. The system is initialized at step 32, which can involve accessing the wire service or stored data from which the articles are received, as well as the map display. The stories can come from any database, not necessarily from a wire service.

At step 34, an article or news message is received. Although not shown, the article if from a wire service, would ordinarily be stored at this point for among other possible reasons, future playback screening for new hotwords or activities.

The filtering begins at step 36 with a determination of whether any of the programmed hotwords are in the article. The programming may be configured so that a single occurrence of a hotword is sufficient to execute a “Yes” output at step 36, or a requirement for a threshold number of occurrences of hotwords may be set.

In either case, if the presence of a hotword is positively indicated, the next step 38, determines whether a programmed location associated with the hotword detected is present. If both a hotword and an associated location of interest are present, the article is considered to be newsworthy and a match is indicated at step 40, whereupon an icon is displayed on the map at the indicted location. It should be noted that since the full text of the article is being screened, the programmed location may institute a “hit” if it appears in the body of the article.

If step 36 results in a determination that a hotword is not present or if step 38 results in a determination that a location of interest in not present, a match is not indicated, but step 42 is performed to determine if any programmed activities of interest are present. As discussed above, each activity is defined by a number of descriptive words or phrases, and a threshold is set so that it is necessary to detect a predetermined number of such words or phrases before an activity is deemed to be present.

If an activity of interest is determined to be present, step 44 is performed to determine if there are any locations of interest which correlate with the activity. If affirmative, then a match is indicated, and an icon is displayed on the map at the appropriate location.

If desired, the step involving checking for locations of interest can be performed only once, before hotwords and activities are screened.

It is significant to note that hotwords are screened before activities. This saves processing time, because activities are defined by a number of words or phrases and thus take longer to screen. Once a hotword is confirmed, assuming an associated location has been found, a match is indicated, without the necessity of screening “activities”. However, in some embodiments, it may be desirable to screen activities even after a hotword has been confirmed and such embodiments, are also within the scope of the invention. In some such embodiments, all three associated hotwords, locations and activities may be required to comprise a match. As will be further detailed below, articles which are not correlated are saved, so that they can be viewed by the operator at a later time, if desired.

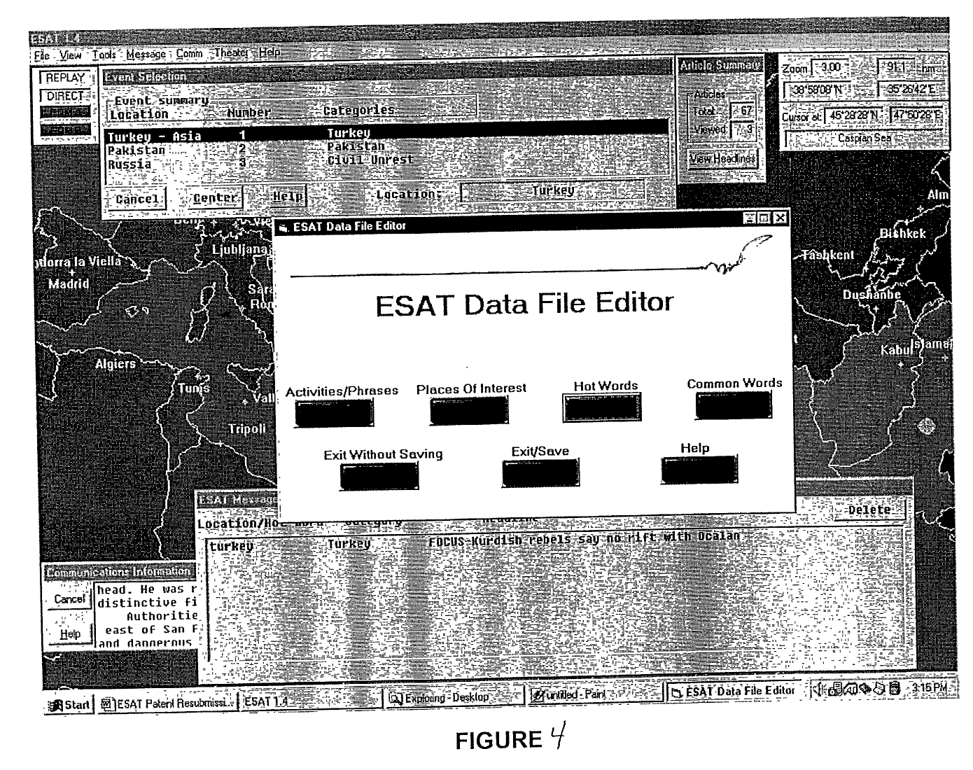

FIGS. 4 to 10 show various screen captures of displays presented, and illustrate the functions which can be accomplished by an actual computer system in which the method and apparatus of the invention may be implemented.

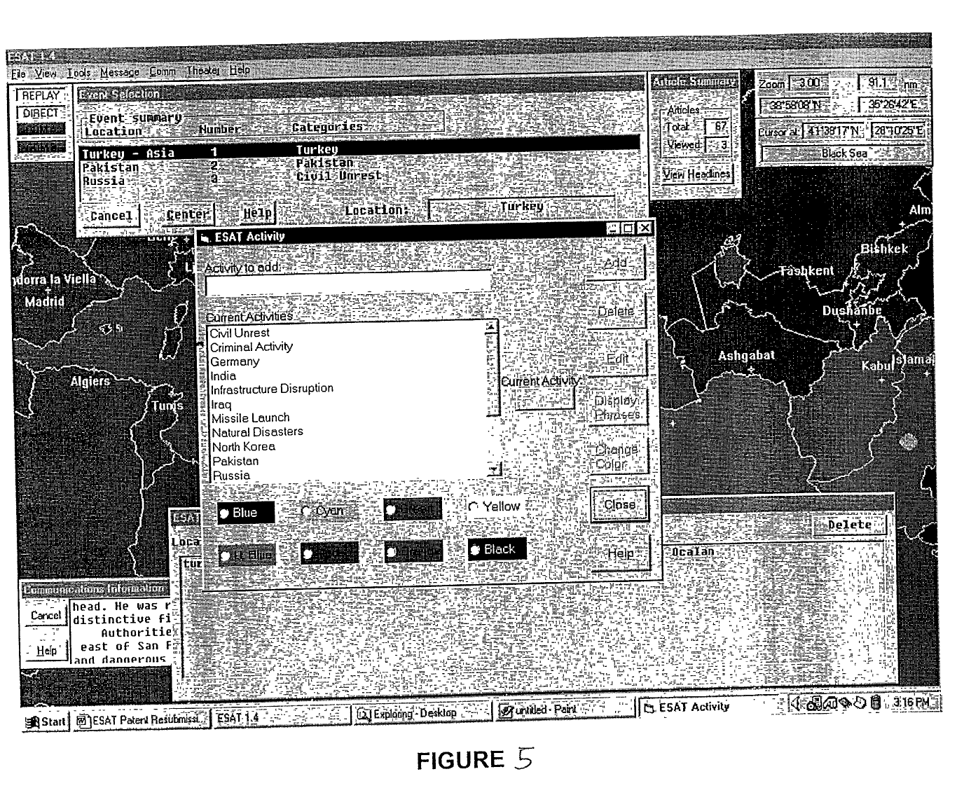

Referring to FIG. 4, a screen capture display relating to a Data File Editor is shown. This interface may be arranged so as to allow the operator to preprogram desired activities/phrases, locations of interest and hotwords directly on the screen. When the activities/phrases button is clicked on, the system is arranged to produce a screen display as shown in FIG. 5, in which the list of current activities is displayed. The operator may add activities by keying them into the “Activity to add” box. The current activities are stored in a database, and added activities are entered to this database.

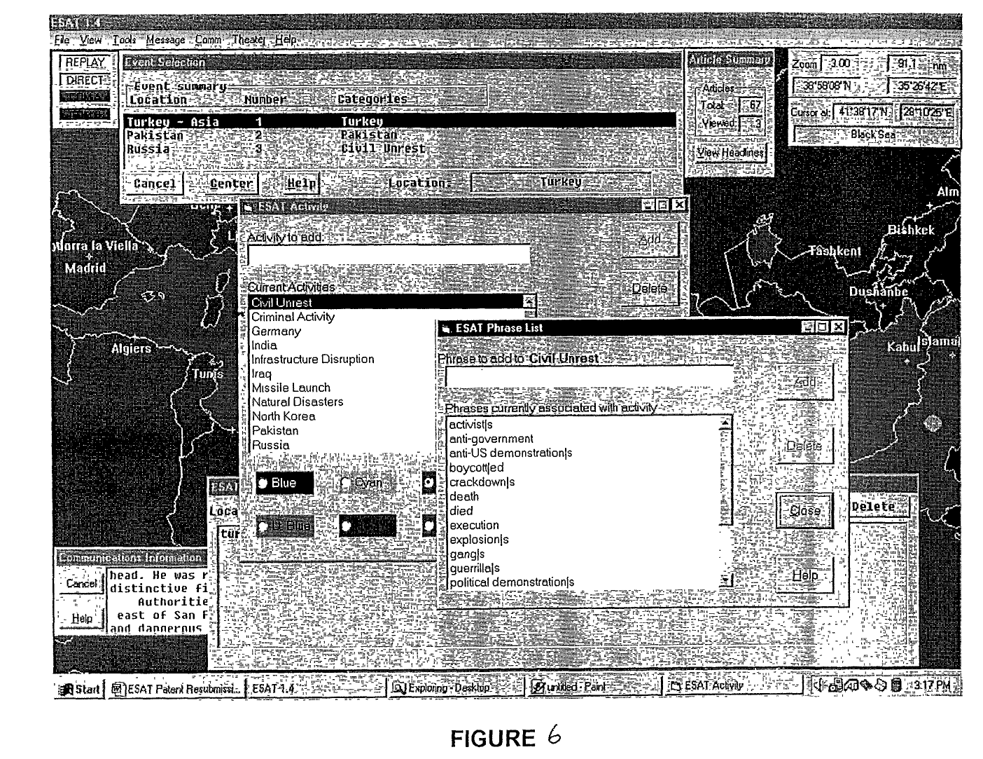

In the screen capture of FIG. 6, the activity Civil Unrest has been clicked on, which produces the Phrase List, which includes those phrases currently associated with the activity Civil Unrest. The operator may add desired phrases by keying them in to the “Phrase to add” box, which causes the additional phrase(s) to be entered to the database relating to activity words and phrases.

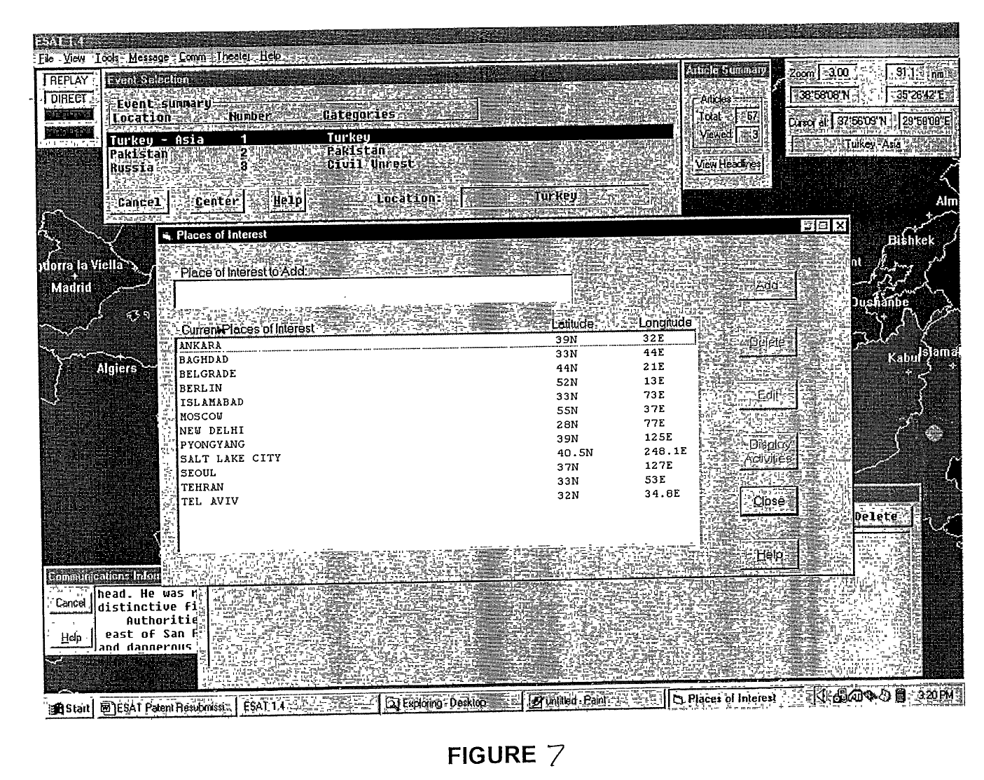

In the screen captive of FIG. 7, the Places of Interest button on the Data File Editor of FIG. 4 has been clicked on. The Current Places of Interest are displayed and places of interest may be added to the relevant database by appropriate keying in. The software may be arranged to automatically correlate places with longitude and latitude.

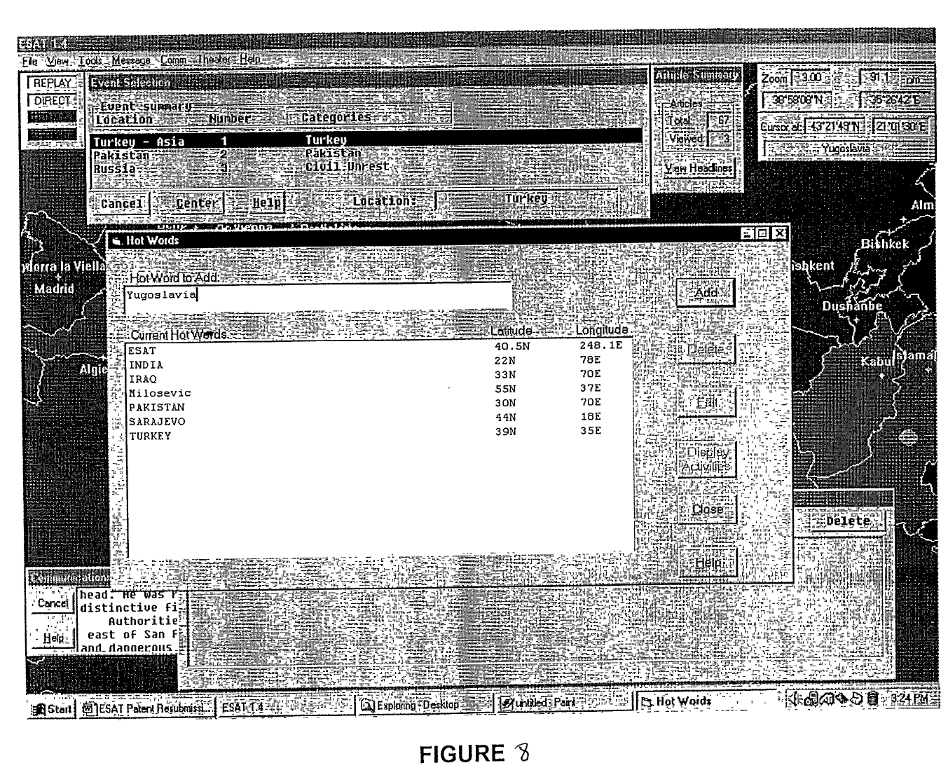

To produce the screen capture of FIG. 8, the Hotwords button on the Data File Edition of FIG. 4 has been clicked on. In FIG. 8, the hotword Yugoslavia is being added to the database of current hotwords. This may be accomplished by clicking on the Add button and putting the cursor on the center of the mass of Yugoslavia on the map. The software is arranged to show the correct latitude and longitude for Yugoslavia in the box at the top right of FIG. 8. When a hotword, location and/or activity are added sequentially, they are associated with each other by the software, or a coding inputted by the operator may be employed to effect such association. This means, referring to the flow chart of FIG. 3, that the detection of associated hotwords and locations, activities and locations, or hotwords, activities and locations defines a match.

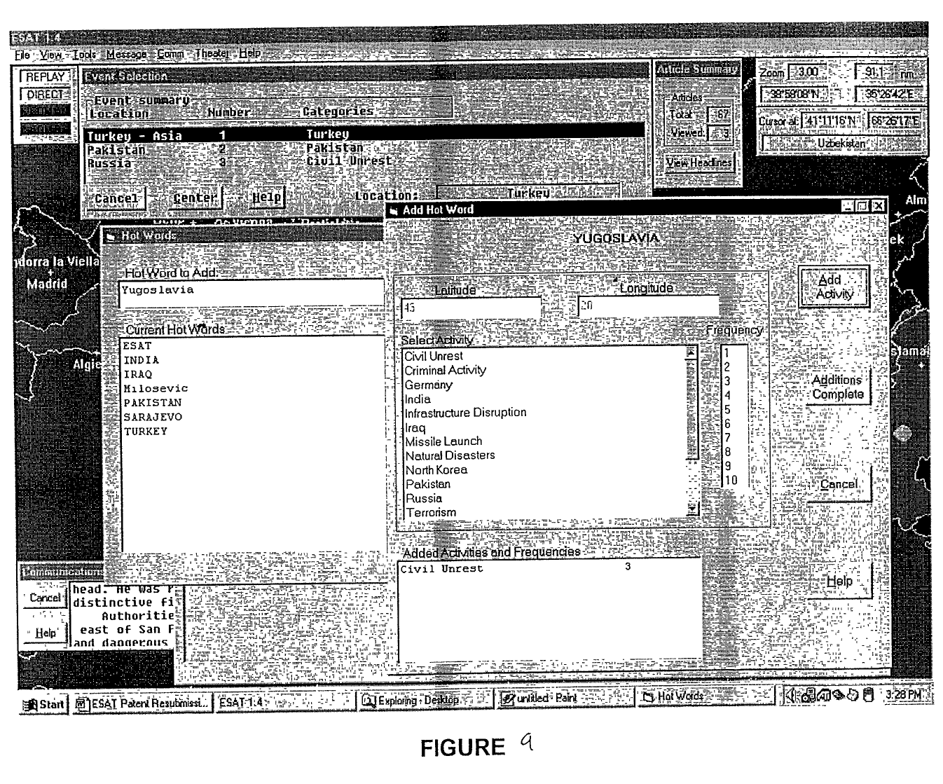

Referring to FIG. 9, it is seen that the hotword Yugoslavia is being entered with the activity civil unrest. If the selected location is also Yugoslavia, then the appearance in an article of the word Yugoslavia and the activity civil unrest define a match. It also remains to specify the required frequency of occurrence of the hotword and/or words and phrases that define the activity. In FIG. 9, referring to the block entitled “Added Activities and Frequencies”, it is noted that a threshold of 3 has been selected meaning that at least 3 words and phrases associated with Civil Unrest must occur in the body of the article. In calculating the count of 3, the word or phrase may repeat itself.

When a place is used as a hotword, it may be associated with a location of interest which is the same as the hotword, in which case any article mentioning the place will be correlated, or with a different location of interest, in which case both the place which is the hotword and the location of interest must be present for a correlation. Referring to FIG. 9, it is also noted that several countries are listed as activities. The phrases corresponding to an “activity” such as “Germany” could for example be German arms, German missile technology and German technical advisers (in Yugoslavia).

Referring again to FIG. 9, the system may be arranged to have an Event Summary box which in the Figure indicates that one article has been correlated on Turkey on a hotword defined by the user as Turkey. Two articles have been correlated on Pakistan on the hotword Pakistan, and three articles have been correlated on Russia on the activity Civil Unrest. As seen on the map, icons have been displayed in Turkey, Pakistan and Russia (which doesn't appear in view of FIG. 7). The icons may be color coded. The system may further be arranged to display the number of articles screened (see Article Summary box). Those articles not correlated can be placed in another dialogue box, which can be opened by the user so that all uncorrelated articles can be viewed to see what may have been missed.

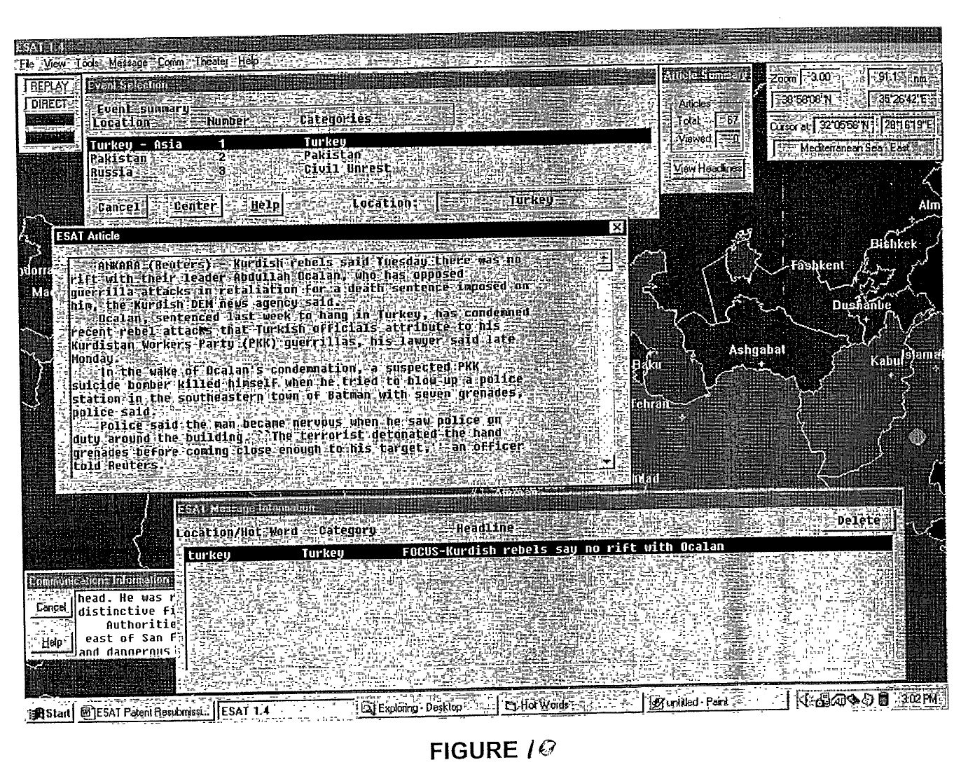

In some embodiments of the invention, the computer may be arranged to display the headlines of correlated articles. For example, referring to FIG. 10, it is seen that the headline of the unrelated article relating to Turkey appears in the Message Information box. The system may be arranged for example, upon user selection to display the entire article, as is seen in the Article box in FIG. 10. Behind the Message Information box, a Communications Information box is seen, which may display the actual news messages that are appearing at the baud rate of the user's modem. The system may be arranged to produce a stored log file which contains all articles processed over the previous 24 hours. This log file may be replayed, and the clock speed may be varied by the user to determine if there are any new correlated events as a result of adding new hotwords, phrases associated with activities, or locations. The system may be provided with the capability to access different theaters (geographical regions), which may be displayed with a variable zoom factor.

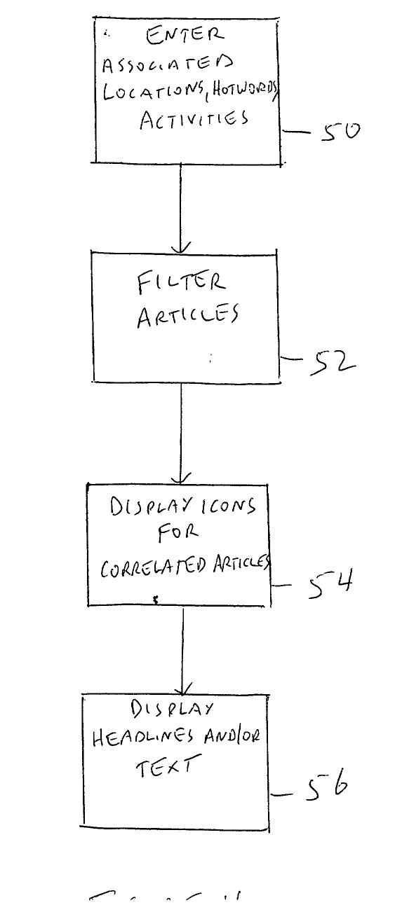

FIG. 11 is a flow chart summarizing the operation described above. At step 50, associated locations, hotwords, and/or activities are selected and entered to appropriate databases. At step 52, the filtering, previously described in connection with FIG. 3 takes place. At step 54, icons pertaining to correlated articles are displayed at the relevant locations on a map, and at step 56, the actual headlines and/or text pertaining to correlated articles is displayed.

While the invention has been described in connection with preferred and illustrated embodiments, variations will occur to those skilled in the art, and the invention to be covered is defined in the following claims.

What is claimed is:

1. A method of displaying information relating to a news story by a computer system, comprising the steps of,
receiving the news story,
determining whether the news story has preprogrammed story content,
determining whether the news story corresponds to a preprogrammed location which is associated with the preprogrammed story content, and
displaying a story indicator on a map at the preprogrammed location if it is determined that both the preprogrammed story content and preprogrammed location are present.

2. The method of claim 1 wherein the step of determining whether the news story has preprogrammed story content comprises determining whether the news story has at least one of preprogrammed hotwords and preprogrammed activities.

3. The method of claim 2 wherein the step of determining whether the news story has at least one of preprogrammed hotwords and preprogrammed activities comprises first determining whether the news story has preprogrammed hotwords.

4. The method of claim 3 wherein if it is determined that no preprogrammed hotwords are present, it is then determined whether a preprogrammed activity is present.

5. The method of claim 4 wherein the step of determining whether a preprogrammed activity is present comprises determining whether at least a predetermined number of words or phrases associated with that activity are present.

6. The method of claim 5 further including the step of storing the news story before it is determined whether it has a preprogrammed story content and corresponds to a preprogrammed location.

7. An apparatus for displaying information relating to a news story, comprising an electrical node for receiving a plurality of news stories,
a memory for storing the received news stories,
an electronic map of a geographical region, and
a processor for
determining whether the news story has preprogrammed story content,
determining whether the news story corresponds to a preprogrammed location which is associated with the preprogrammed story content, and
displaying a story indicator on a map at the preprogrammed location if it is determined that both preprogrammed story content and preprogrammed location are present.

8. The apparatus of claim 7 wherein the step of determining whether the news story has preprogrammed story content comprises determining whether the news story has at least one of preprogrammed hotwords and preprogrammed activities.

9. The apparatus of claim 8 wherein the step of determining whether the news story has at least one of preprogrammed hotwords and preprogrammed activities comprises first determining whether the news story has preprogrammed hotwords.

10. The apparatus of claim 9 wherein if it is determined that no preprogrammed hotwords are present, it is then determined whether a preprogrammed activity is present.

11. The apparatus of claim 10 wherein the step of determining whether a preprogrammed activity is present comprises determining whether at least a predetermined number of words or phrases associated with that activity are present.

12. A computer readable medium of claim 11 containing programming instructions for accomplishing display of information relating to a news story, the computer readable medium containing instructions for,
receiving the news story
determining whether the news story has preprogrammed story content,
determining whether the news story corresponds to a preprogrammed location which is associated wit the preprogrammed story content, and
displaying a story indicator on a map at the preprogrammed location if it is determined that both preprogrammed story content and preprogrammed location are present.

13. The computer readable medium of claim 12 wherein the step of determining whether the news story has preprogrammed story content comprises determining whether the news story has at least one of preprogrammed hotwords and preprogrammed activities.

14. The computer readable medium of claim 13 wherein the step of determining whether the news story has at least one of preprogrammed hotwords and preprogrammed activities comprises first determining whether the news story has preprogrammed hotwords.

15. The computer readable medium of claim 14 wherein if it is determined that no preprogrammed hotwords are present, it is then determined whether a preprogrammed activity is present.
